(19) United States
(12) Patent Application Publication
(10) Pub. No.: US 2022/0101357 A1
(43) Pub. Date: Mar. 31, 2022

(54) RECIPIENT SESSION ATTRIBUTION FOR A/B EXPERIMENTATION

(71) Applicant: Microsoft Technology Licensing, LLC, Redmond, WA (US)

(72) Inventors: Derek KOH, San Mateo, CA (US); Qiannan YIN, Sunnyvale, CA (US); Hao WU, Belmont, CA (US); Damien Albert Louis COULLON, Santa Clara, CA (US); Kiran PRASAD, Saratoga, CA (US)

(21) Appl. No.: 17/037,728

(22) Filed: Sep. 30, 2020

(51) Int. Cl. G06Q 30/02; G06Q 10/10; G06Q 50/00; G06F 9/54

(52) U.S. Cl. CPC G06Q 30/0204; G06F 9/542; G06Q 50/01; G06Q 10/107

(57) ABSTRACT

Computer-implemented techniques for recipient session attribution in an online service. When the techniques are implemented in the context of an online service in which end-users are alerted about the online end-user actions of other end-users, the impact of the online actions on the online session activity of the recipients of the alerts can be measured post-hoc, after the online actions have been taken and the online sessions have been conducted. The techniques may be implemented in the context of a single-randomization AB experiment with the online service to measure the recipient session impact of the treatment feature of the experiment where the end-user action under test of the experiment is an alert-triggering action.

### TECHNICAL FIELD

The present disclosure relates to online application services such as, for example, large-scale online application services offered to end-users over the internet. More specifically, some embodiments of the present disclosure relate to recipient session attribution for online application services in the context of A/B experimentation.

### BACKGROUND

Operators of online application services want to keep their end-users engaged with the services. Measuring end-user engagement is important aspect of determining how best to keep end-users engaged. There are various metrics that directly measure engagement. These direct metrics include number of pageviews, average session duration, bounce rate, top exit pages, pages per session, page/scroll depth, unique visitors, new versus returning visitors, conversion rate, shopping cart abandonment rate, among others.

Direct metrics measure the direct impact of online application service features on end-user engagement. Direct metrics are collected in the context of an A/B experiment to determine how a new feature directly impacts the level of engagement with a type of primary end-user action under test. For example, the type of primary end-user action under test might be end-users sending invitations to other end-users to connect in an online social network. In this example, an A/B experiment might be conducted to determine whether a new feature results in end-users sending more invitations to connect than an existing feature. For example, the new feature might be a change in the placement or coloring of the “Send Invite” button in a graphical user interface. This is just one example of a possible new feature that could be evaluated with an A/B experiment. The online service features that could be directly evaluated with an A/B experimentation is virtually limitless.

While direct metrics are useful for measuring the direct impact of new features on primary end-user actions, direct metrics provide an incomplete picture of the secondary impact of new features in situations where the type of primary action under test can cause secondary end-user actions. For example, sending invitations to connect in an online social network can cause recipients of the invitations to start online sessions with the service to accept, reject, or ignore the invitations. In this example, an end-user starting a session with the online social network is an example of a secondary end-user action that is caused by the inviting end-user sending the invitation.

With an A/B experiment, there may be a single randomization of end-users into treatment and control groups and direct metrics are collected to measure the direct impact of the new feature on the type of primary action under test. Because of the single randomization, a recipient end-user taking a secondary action can either be in the treatment group or control group. As a result, the secondary impact of the new feature on the secondary actions is typically not measured with direct metrics.

One possible way to measure the secondary impact of a new feature on secondary end-user actions is with a dual-randomization experiment. With a dual-randomization experiment, two A/B experiments are conducted simultaneously. To reduce or eliminate bias in a dual-randomization experiment, experiment “gates” may be programmed or configured in the online service to achieve an orthogonal randomization of end-users between the two A/B experiments.

Unfortunately, installation of an experiment gate often requires modification to the configuration of the online service to prevent certain end-users in the experiments from interacting with each other with respect to the type of primary end-user action under test. Such modifications can require custom software programming which consumes time and expense to develop and test. The modifications also have the potential to introduce software bugs into the production computing environment of the online service which may affect the end-user experience with the online service in undesired ways.

The present disclosure addresses this and other issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Some embodiments of the present invention are illustrated by way of example, and not in way by limitation, in the figures of the accompanying drawings and in which like reference numerals refers to similar elements and in which:

FIG. 1 illustrates an example networked computing environment in which some embodiments may be practiced.

FIG. 2A illustrates a single-randomization A/B experiment, according to some embodiments of the present invention.

FIG. 2B depicts initiating and recipient end-users in a single-randomization A/B experiment, according to some embodiments of the present invention.

FIG. 3A illustrates an example e-mail message that alerts a recipient end-user of an alert-triggering action taken using a client application and an online service by an initiating end-user, according to some embodiments of the present invention.

FIG. 3B illustrates an example push notification that alerts a recipient end-user of an alert-triggering action taken using a client application and an online service by an initiating end-user, according to some embodiments of the present invention.

FIG. 3C illustrates an example badge notification that alerts a recipient end-user of an alert-triggering action taken using a client application and an online service by an initiating end-user, according to some embodiments of the present invention.

FIG. 3D illustrates examples of badge notification that alert a recipient end-user of alert-triggering actions taken using a client application and an online service by one or more initiating end-users, according to some embodiments of the present invention.

FIG. 4 illustrates example software and storage components of an online service in accordance with some embodiments of the present invention.

FIG. 5 is a flowchart of an example process for recipient session attribution in the context of A/B experimentation, according to some embodiments of the present invention.

FIG. 6 is a block diagram that illustrates a computer system upon which some embodiments may be implemented.

### DETAILED DESCRIPTION

In the following description, for the purposes of explanation, numerous specific details are set forth in order to provide a thorough understanding of some embodiments of the present invention. It will be apparent, however, that some embodiments may be practiced without these specific details. In other instances, well-known structures and devices are shown in block diagram form in order to avoid unnecessarily obscuring some embodiments.

The detailed description is organized below according to the following outline:

### 1.0 GENERAL OVERVIEW

### 2.0 EXAMPLE COMPUTING ENVIRONMENT

### 3.0 RECIPIENT SESSION ATTRIBUTION IN CONTEXT OF A/B EXPERIMENTATION

### 4.0 EXAMPLE ALERTS

### 5.0 EXAMPLE ONLINE SERVICE COMPONENTS

### 6.0 EXAMPLE PROCESS

### 7.0 HARDWARE IMPLEMENTATION

### 8.0 OTHER ASPECTS OF THE DISCLOSURE

### 1. GENERAL OVERVIEW

Computer-implemented techniques are disclosed for recipient session attribution in the context of A/B experimentation. According to some embodiments, an implementation of the techniques encompasses a computer-implemented method performed by one or more computer systems comprising one or more processors (a computing system) and computer storage media. One or more computer programs comprising computer-executable instructions configured to perform the method are stored in the computer storage media. The instructions are executed by the computing system to perform the method.

The method includes the step of the computing system identifying online end-user sessions (sessions) of an online service. A session encompasses a continuous period of time that an end-user is deemed by the computing system to be continuously using the online service. According to some embodiments, the computing system identifies the sessions by analyzing session log data compiled by the online service.

The method further includes the step of the computing system identifying online end-user activity alerts (alerts) communicated by the online service. An alert may encompass, for example, an e-mail message, an application badge notification, or an application push notification communicated by the online service in response to an online end-user action (action) taken using the online service. According to some embodiments, the computing system identifies the alerts by analyzing alert log data compiled by the online service.

The method also includes the step of the computing system attributing a subset of the sessions to a subset of the alerts. The computing system may attribute a session to an alert if the computing system determines that log data indicates that the alert triggered the session. The subset of sessions triggered by the subset of alerts is sometimes referred to herein as the “the recipient sessions” and the subset of alerts that triggered the recipient sessions is sometimes referred to herein as “the session-triggering alerts.” According to some embodiments, the computing system analyzes the session log data and the alert log data to attribute the recipient sessions to the session-triggering alerts.

The method additionally includes the step of the computing system determining the actions taken using the online service that caused the online service to communicate the session-triggering alerts. Certain actions taken using the online service may cause the online service to communicate alerts of the actions. Such actions may include, but are not limited to, posting a content item in an online social network, sending an invitation to connect in an online social network, resharing a content item in an online social network, sending a private message to one or more other users of an online service, reacting to a content item post in a personalized content item feed, and commenting on a content item post in a personalized content item feed. The actions taken that caused the session-triggering alerts are sometimes referred to herein as “the alert-triggering actions.” According to some embodiments, the computing system analyzes activity log data and the alert log data to determine the alert-triggering actions.

Further still, the method includes the step of the computing system attributing the recipient sessions to the alert-triggering actions. A recipient session may be attributed to an alert-triggering action if the recipient session is attributed to a session-triggering alert caused by the alert-triggering action. According to some embodiments, the computing system fractionally attributes a recipient session to multiple alert-triggering actions where the recipient session is attributed to multiple session-triggering alerts.

According to some embodiments, an implementation of the techniques encompasses one or more non-transitory storage media storing the instructions configured to perform any of the foregoing methods.

According to some embodiments, an implementation of the techniques encompasses a computing system having one or more processors, storage media, and the instructions configured to perform any of the foregoing methods stored in the storage media for execution by the computing system.

When implemented in the online service, the techniques improve the operation of the online service. With the techniques, the secondary impact on recipient session activity can be measured in the context of conducting a single-randomization A/B experiment. For example, a count of the recipient sessions attributed to alert-triggering actions of end-users in the treatment group of the A/B experiment can be compared to the count of recipient sessions attributed to alert-triggering actions of end-users in the control group of the A/B experiment. Conducting a dual-randomization A/B experiment is not required in order to measure the secondary impact on recipient session activity. Consequently, the technical issues and complexity associated with installation of experiment gates can be avoided.

The foregoing and other embodiments will now be described in greater detail with respect to the figures.

### 2. EXAMPLE COMPUTING ENVIRONMENT

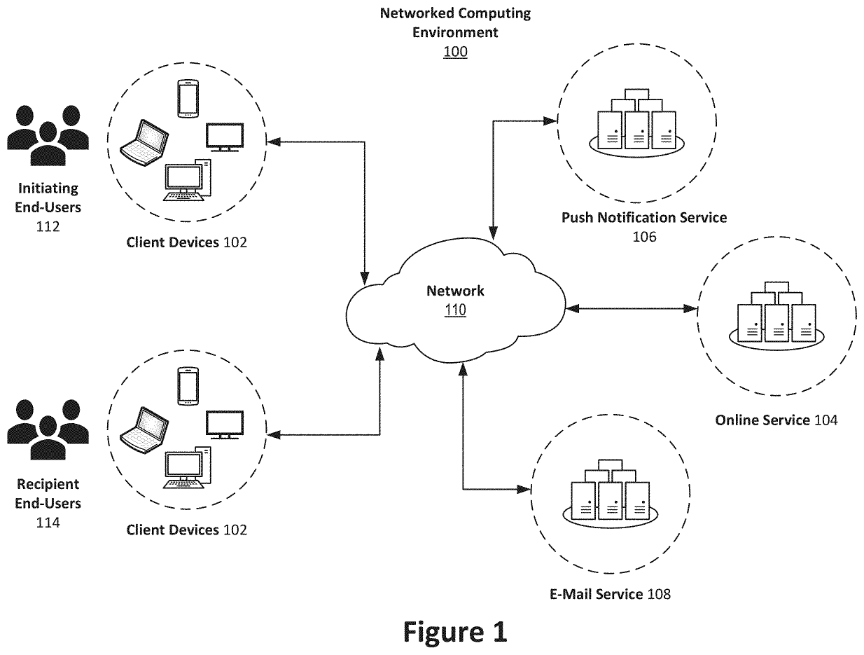

FIG. 1 illustrates an example networked computing environment in which some embodiments may be implemented. FIG. 1 is shown in simplified, schematic format for purposes of illustrating a clear example and other embodiments may include more, fewer, or different elements. Environment 100 includes client devices 102, online service 104, push notification service 106, e-mail service 108, data communications network 110 (referred to hereinafter as just “network 110”), initiating end-users 112 and recipient end-users 114.

A client device 102 (collectively “client devices 102”) is a personal computing device such as, for example, a laptop computer, a smart phone, a tablet computer, a desktop computer, a workstation computer, or the like. Client devices 102 are viewed as clients of online service 104 as in a client-server computing architecture. A client device 102 is capable of being wired or wirelessly coupled to network 110 such as, for example, via an IEEE 802.3 (ethernet) network, an IEEE 802.11 (WLAN) network, or a cellular network (e.g., based on FDMA, TDMA, CDMA, W-CDMA, or OFDMA technology). A client device 102 has or is electrically coupled to a computer video display for presenting a computer graphical user interface. A client device 102 is configured with an operating system for running computer applications used by end-users of the client device 102. Examples of suitable operating systems include MICROSOFT WINDOWS, APPLE IOS, GOOGLE ANDROID, APPLE MACOS, LINUX, or the like. However, no particular type or types of client devices 102 are required and other types may be used as one skilled in the art will recognize from the teachings of this disclosure.

A client device 102 is configured with a client application for interacting with online service 104. The client application may be a web browser application, a mobile application or colloquially an “app” (e.g., an APPLE IOS or GOOGLE ANDROID app downloaded from app store), or a so-called “thick” or “dedicated” client application. The client application may be used to drive an interactive graphical user interface of the client application presented at a client device 102 based on information sent and received via network 110 to and from online service 104 and in response to end-user input at the client device (e.g., keyboard input, pointing device input, speech input, touch gesture input, video input captured by a camera of the client device, bio input (e.g., fingerprints), etc.) The client application may be implemented using various technologies including, for example, one or more of the following technologies: HTML, HTTP, HTTPS, JAVASCRIPT, JAVA, SWIFT, and OBJECTIVE-C.

Online service 104 may be implemented with one or more server computer systems housed in one or more data centers or other computing hosting facilities connected to network 110. Online service 104 provides one or more domain-specific services to its end-users. No particular domain-specific service or set of domain-specific services is required and one skilled in the art will recognize from the teachings of this disclosure that various different types of services may be provided by online service 104. In some embodiments, online service 104 is the LINKEDIN employment-oriented online service provided by LINKEDIN CORPORATION of Sunnyvale, Calif.

From the perspective of online service 104, there are two categories of conceptual end-users of client devices 102: initiating end-users 112 (singularly “initiating end-user 112”) and recipient end-users 114 (singularly “recipient end-user 114”). At a high level, an initiating end-user 112 uses the client application at a client device 102 to take an “alert-triggering” online action using online service 104. One or more recipient end-users 114 are alerted by online service 104 about the alert-triggering action taken by the initiating end-user 112.

With respect to a given alert-triggering online action and an alert thereof, the initiating end-user 112 is the end-user that took the alert-triggering action that triggered communication of alert by online service 104. A recipient end-user 112 is an end-user to whom the alert is communicated with online service 104. In some instances, a single alert-triggering action can trigger communication of multiple alerts to multiple of the recipient end-users 114. An “alert-triggering” online action is an online action taken by an initiating end-user 112 using the client application and online service 104. The online action causes online service 104 to communicate one or more alerts about the action taken to one or more recipient end-users 114 of online service 104.

Examples of an alert-triggering action include sending an invitation, private messaging, posting a content item, reacting to a posted content item, commenting on a posted content item, and resharing a posted content item.

Online service 104 may provide graphical user interface controls for invitation features that allow end-users to invite other end-users to join online service 104 or connect with the end-user through online service 104. For example, end-user Abe may use the client application and online service 104 to send an invitation to end-user Bara to create a user account (sign up or join) with online service 104. As another example where online service 104 implements a social network, end-user Abe may use the client application and online service 104 to send an invitation to end-user Bara to connect in the social network (e.g., establish a reciprocal first-degree connection in the social network). In either case, online service 104 may communicate an alert to end-user Bara. The alert may inform of the invitation. For example, the alert might information Bara that she has “A new invitation from Abe” and provide a URL or other hyperlink to a graphical user interface of the client application for viewing the invitation and taking an action on the invitation. For example, the action might be accepting, rejecting, or ignoring the invitation.

Online service 104 may provide graphical user interface controls for messaging features that allow end-users to compose and send private messages to each other through online service 104. For example, end-user Abe may use the client application and online service 104 to compose and send a text or mixed-media message addressed to one or more other end-users of online service 104 (e.g., end-users Bara and Chrix).

Online service 104 may communicate an alert to each of the addressed end-users (e.g., Bara and Chrix) informing of the message. An example of such a messaging feature is LINKEDIN INMAIL available as part of the LINKEDIN employment-oriented online service provided by LINKEDIN CORPORATION of Sunnyvale, Calif. Another example of such a messaging feature is FACEBOOK MESSENGER available as part of the FACEBOOK social networking online service provided by FACEBOOK, INC. of Menlo Park, Calif. For example, an alert might inform Chrix that he has “A new message from Abe” and provide a URL or other hyperlink to a graphical user interface of the client application for viewing the message and possibly composing a reply message thereto.

Online service 104 may provide graphical user interface controls for personalized content item feed features that allow end-users to post content items for presentation in other end-users' personalized content item feeds. A content item post may contain end-user authored content or assemblage of content. The content may encompass one or more of text, video, audio, video and audio, graphics, icons, photos, images, uniform resource locators (URLs) or other hyperlinks, etc. A content item post is not necessarily specifically addressed to any particular end-user, although one or more end-users may be “tagged” in the post. Instead, online service 104 may select the post for presentation in a particular end-user's personalized content feed based on a variety of factors including whether the particular end-user is tagged in the post or based on a determination with online service 104 that the particular end-user is likely to be interested in the post.

Online service 104 may communicate an alert to each end-user for which online service 104 has selected to include a particular content item post in their personalized content item feed. For example, an alert communicated to Bara that is connected to Abe in a social network might inform Bara that “There is an update from Abe” or “There is a new post from Abe” and provide a URL or hyperlink to a graphical user interface of the client application that presents Abe's post in the context of Bara's personalized content item feed.

Online service 104 may provide graphical user interface controls for personalized content item feed features that allow end-users to react to content item posts in their personalized content item feeds. Such reactions may express an end-user sentiment with respect to the content item post such as, for example, “Like,” “Love,” “Care,” “Haha,” “Wow,” “Sad,” “Angry,” “Celebrate,” “Support,” “Insightful,” or “Curious.”

Online service 104 may communicate an alert to an end-user when another end-user reacts to one of their content item posts. For example, an alert communicated to Chrix might state that “Bara liked your post” and provide a URL or a hyperlink to a graphical user interface of Chrix's content item post with Bara's “Like” reaction.

Online service 104 may provide graphical user interface controls for personalized content item feed features that allow end-users to comment in text-form or post-form on content item posts in their personalized content item feed.

Online service 104 may communicate an alert to an end-user when another end-user comments on one of their content item posts. For example, an alert communicated to Bara might state that “Chrix commented on your post” and provide a URL or a hyperlink to a graphical user interface of Bara's content item post with Chrix's comment.

Online service 104 may provide graphical user interface controls for personalized content item feed features that allow end-users to reshare content item posts from their personalized content item feed.

Online service 104 may communicate an alert to an end-user when another end-user reshares one of their content item posts from the other end-user's personalized content item feed to additional end-users. For example, an alert communicated to Abe might state that “Bara reshared your post” and provide a URL or a hyperlink to a graphical user interface of Abe's content item post with an indication that the post has been reshared. An alert of an alert-triggering action communicated by online service 104 to a recipient end-user 114 can take different forms. Some of the forms an alert can take include e-mail, push notification, and badge notification.

Generally, however, an alert is an electronic communication that informs or notifies a recipient user 114 of one or more alert-triggering actions taken by one or more initiating users 112 using the client application and online service 104. An alert is typically a separate communication by online service 104 separate from the result of an action taken by an initiating user 112. For example, for a message or invite sent by an initiating user 112 or a content item post made by an initiating user 112, the alert communicated is not the message, invite or post itself. Rather, the alert is a separate communication notifying of a recipient user 114 that online activity has taken place using online service 104. The alert typically includes a URL or a hyperlink that, when activated by the recipient user 112, navigates the client application to a graphical use interface that provides more information about the online activity that is the subject of the alert.

E-mail service 108 provides the capability of sending e-mail messages to recipient end-users 114. E-mail service 108 offers an application programming interface (API) that can be invoked over network 110 for sending e-mail alerts to recipient end-user 114 about alert-triggering actions taken. Sending of an e-mail message may involve e-mail service 108 placing an electronic copy of the e-mail message in a server-stored electronic e-mail message box of a recipient end-user 114 for later retrieval over network 110 by a client device 102 of the recipient end-user 114 using a network protocol for receiving e-mail messages such as the Post-Office Protocol (POP) or the Internet Message Access Protocol (IMAP). While e-mail service 108 can be a third-party service operated and offered by a different service provider than online service 104, e-mail service 108 and online service 104 can be operated by the same service provider. An e-mail message alert of an alert-triggering action may be formatted according to an internet standard such as RFC 5322, its progeny, or the like.

Push notification service 106 provides the capability of sending push notifications to recipient end-users 114. Push notification service 106 offers an application programming interface (API) that can be invoked over network 100 for sending push notifications to recipient end-users 114 about alert-triggering actions taken. While push notification service 106 can be a third-party service operated and offered by a different service provider than online service 104, push notification service 106 and online service 104 can be operated by the same service provider.

Network 110 may be the internet. In this case, a client device 102 may connect to network 110 via a wired or wireless local area network (e.g., an IEEE 802.3 (ethernet) network or an IEEE 802.11 (WLAN) network) and an internet service provider (ISP). A client device 102 may also be connected to network 110 via a cellular network (e.g., based on FDMA, TDMA, CDMA, W-CDMA, or OFDMA technology). Online service 104 may be connected to network 110 via a public peering network or a public autonomous system, which itself may be considered part of the internet. E-mail service 106 and push notification service 108 may likewise connect to network 110. It is also possible for online service 104 to communicate with e-mail service 106 or push notification service 108 via a private peering network.

### 3. RECIPIENT SESSION ATTRIBUTION IN CONTEXT OF A/B EXPERIMENTATION

A single-randomization A/B experiment can be conducted with online service 104 to determine whether a particular treatment feature causes initiating end-users 112 to take more alert-triggering end-user actions. For example, a single-randomization A/B experiment can be conducted with online service 104 to determine whether a change to the graphical user interface workflow for sending invitations to connect in a social network cause initiating end-users 112 in the treatment group of the experiment to send more invitations to connect than initiating end-users 112 in the control group of the experiment that use the existing or alternative graphical user interface workflow.

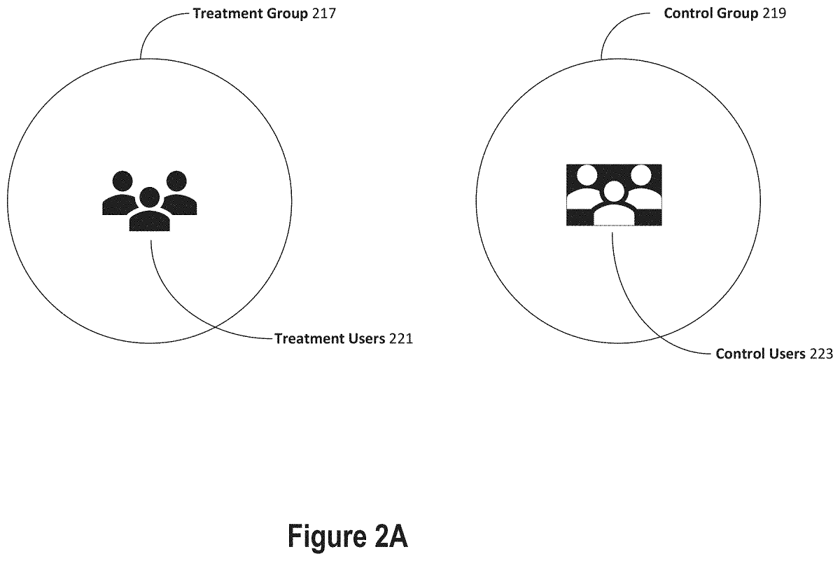

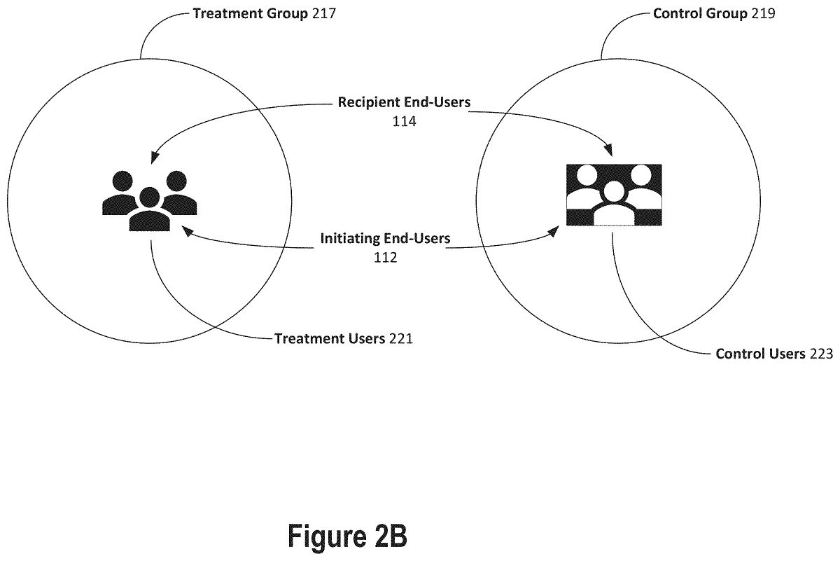

FIG. 2A depicts a single-randomization A/B experiment conducted with online service 104, according to some embodiments of the present invention. The A/B experiment may be conducted to test the primary impact of a treatment feature on a type of alert-triggering action. For example, the type of alert-triggering action may be one of the types of alert-triggering actions discussed above (e.g., sending invitations to connected in an online social network). In particular, the A/B experiment may be conducted to test whether the treatment feature causes end-users to take the type of alert-triggering action more often thereby causing increased engagement with online service 104.

To conduct the A/B experiment, end-users are randomly assigned to either treatment group 217 or control group 219. For example, Bernoulli randomization may be used to randomly assign end-users to either treatment group 217 or control group 219. End-users assigned to treatment group 217 are referred to as treatment users 221. End-users assigned to control group 219 are rereferred to as control users 223. When using the client application to interact with online service 104, treatment users 221 are exposed to the treatment feature and control users 223 are not exposed to the treatment feature. When using the client application to interact with online service 104, control users 223 are exposed to an existing or alternative version of the treatment feature.

As an example, the treatment feature might be a change in the location of the graphical user interface controls for leaving a comment on a content item post in a social networking content item feed. For example, the existing controls might be displayed at the bottom of content item posts and the treatment feature might be displayed in the upper-right hand corner of the posts. The hypothesis of the experiment might be that end-users will leave more comments on content item posts if the controls are displayed in the upper-right hand corner of posts rather than below the contents of posts where end-users might be more inclined to skip over the controls to view the following content item post in the content item feed. This is just one example of a possible A/B experiment that may be conducted with online service 104.

With a single-randomization A/B experiment, because of the randomization of treatment users 221 and control users 223 into the separate treatment and control groups 217 and 219, respectively, the primary impact of the treatment feature can be measured with a comparison based on the number of treatment users 221 that took, or the number of times that treatment users 221 took, the type of alert-triggering action under test (e.g., commenting on content item posts or sending invitations to connect, etc.) and the number of control users 223 that took, or the number of times that control users 223 took, the type of alert-triggering action under test.

However, a single-randomization A/B experiment would not quantify the secondary impact of the treatment feature on the recipients of alerts triggered by treatment users 221 and control users 223 taking the type of alert-triggering action under test. This is because the recipient end-users can be in both the treatment group 217 and the control group 219. In some cases, a recipient end-user may not be in either the treatment group 217 or the control group 219, if the recipient end-user was never randomly assigned to either group 217 or 219. FIG. 2B depicts that both initiating end-users 112 and recipient end-users 114 can be in both the treatment group 217 and the control group 219 in a single-randomization A/B experiment. That is, treatment users 221 may include a mix of initiating end-users 112 and recipient end-user 114 and control users 223 may also include a mix of initiating end-users 112 and recipient end-users 114.

In particular, counting the number of treatment users 221 that responded, or the number of times that treatment users 221 responded, to an alert triggered by the type of alert-triggering action under test (e.g., responded by starting a session with online service 104) does not quantify the number of end-users that responded, or the number of times that end-users responded, to an alert triggered by a treatment user 221 taking the type of alert-triggering action under test. Likewise, counting the number of control users 223 that responded, or the number of times that control users 223 responded, to an alert triggered by the type of alert-triggering action under test (e.g., by starting a session with online service 104) does not quantify the number of end-users that responded, or the number of times that end-users responded, to an alert triggered by a control user 223 taking the type of alert-triggering action under test. Thus, a single-randomization A/B experiment typically cannot by itself be used to measure the secondary impact of the treatment feature on the recipients of alerts triggered by treatment users 221 and control users 223 taking the type of alert-triggering action under test.

According to some embodiments, to accurately quantify the recipient impact of a single-randomization A/B experiment, recipient sessions of recipient users 114 are attributed to alert-triggering actions of initiating end-users 112. With such attribution, the recipient impact of the treatment feature can be accurately measured. In particular, the recipient sessions of recipient end-users 114 attributed to the alert-triggering actions of initiating end-users 112 in the treatment group 217 can be counted and compared to the recipient sessions of recipient end-users 114 attributed to the alert-triggering actions of initiating end-users 112 in the control group 219. With such attribution, the recipient impact on recipient sessions of recipient end-users 114 attributed to a particular set of alert-triggering actions can be measured in the context of a single-randomization A/B experiment.

### 4. EXAMPLE ALERTS

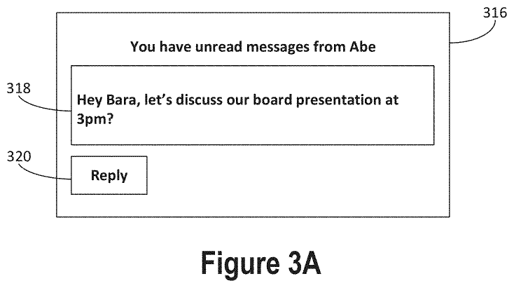

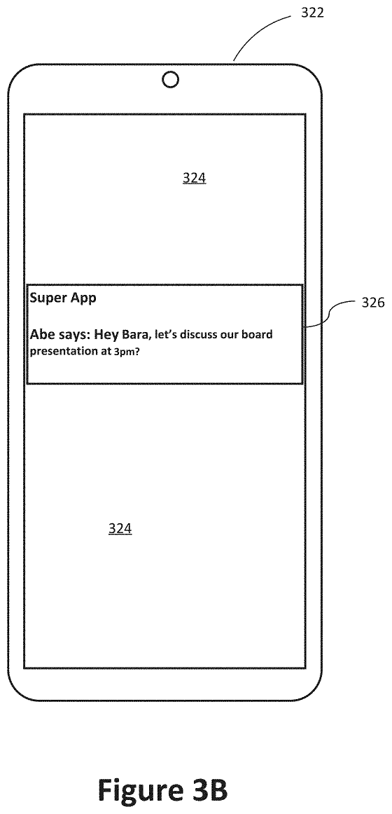

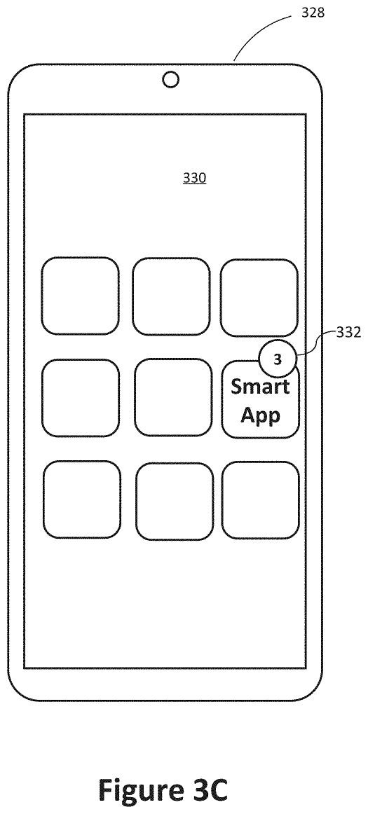

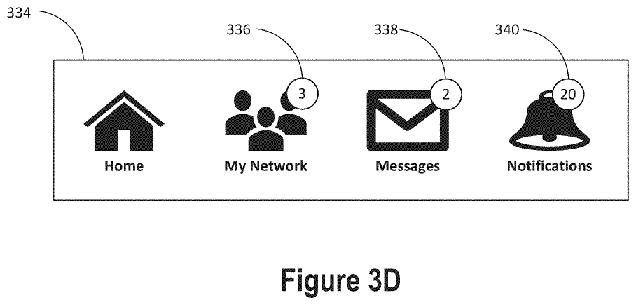

FIG. 3A illustrates an example e-mail message that alerts a recipient end-user of an alert-triggering action taken using a client application and an online service by an initiating end-user, according to some embodiments of the present invention.

E-mail message 316 is presented in a graphical user interface at a client device 102 of a recipient end-user 114. E-mail message 316 alerts the recipient end-user 114 (“Bara”) of an alert-triggering action taken by initiating end-user 112 (“Abe”). In this example, the alert-triggering action is Abe sending an electronic message to Bara using the client application and using online service 104. E-mail message 316 includes the text 318 of the message from Abe and graphical user interface controls 320 for replying to the message from Abe. If end-user Bara activates graphical user interface controls 320, then the client application is launched at Bara's client device 102 presenting a graphical user interface that allows Bara to reply to Abe's message using the client application and using online service 104.

While in this example e-mail message 316 includes the text 318 of Abe's message, e-mail message 316 could omit text 318 and simply inform Bara that she has an unread message from Abe. In this case, e-mail message 316 may provide graphical user interface controls for launching the client application presenting a graphical user interface for viewing the text 318 of the message from Abe. That graphical user interface of the client application may also provide graphical user interface controls for replying to Abe's message.

FIG. 3B illustrates an example push notification that alerts a recipient end-user of an alert-triggering action taken using a client application and an online service by an initiating end-user, according to some embodiments of the present invention.

Push notification 326 is presented in the display screen 324 of mobile phone 322. Push notification 326 alerts the recipient end-user 114 (“Bara”) of an alert-triggering action taken by initiating end-user 112 (“Abe”). In this example, the alert-triggering action is Abe sending an electronic message to Bara using the client application and using online service 104. Push notification 316 includes the text 318 of the message from Abe.

Push notification 316 may be interactive. If end-user Bara interacts with push notification 326 (e.g., with a touch gesture directed to push notification 326 on touch-sensitive display 324), then the client application may be launched at mobile phone 322 presenting a graphical user interface that allows Bara to view or reply to Abe's message using the client application and using online service 104. While in this example push notification 326 includes the text of Abe's message, push notification 326 could omit text and simply inform Bara that she has an unread message from Abe.

FIG. 3C illustrates an example badge notification that alerts a recipient end-user of an alert-triggering action taken using a client application and an online service by an initiating end-user, according to some embodiments of the present invention.

Badge alerts 332 are displayed on display screen 330 as an overlay to a launch icon for the client application at mobile phone 328. Badge alerts 332 alert the recipient end-user 114 of three alert-triggering actions taken by one or more initiating end-users 112. If the recipient end-user 114 activates the launch icon of the client application (e.g., with a touch gesture directed to the launch icon of the client application on touch-sensitive screen 330), then the client application is launched at mobile phone 328.

Upon launch, the client application may present a graphical user interface that presents a summary or description or other indication of the three alert-triggering actions. The recipient end-user 114 can then take further action with respect to a selected one of the three alert-triggering actions. For example, assume the recipient end-user 114 is “Bara” and the three alert-triggering actions are: (1) end-user “Abe” resharing a content item post of “Bara,” (2) end-user “Chrix” reacting to a content item post of “Bara,”, and (3) end-user “Abe” sending a private message to “Bara.” In this example, the graphical user interface presented by the client application after launching the client application may summarize the three alert-triggering actions in the same graphical user interface (e.g., same web page) of the client application or the same scrollable graphical user interface (e.g., same scrollable web page) of the client application. The summary may be interactive such that the recipient end-user 114 can take further action with respect to a selected one of the alert-triggering actions. For example, the summary graphical user interface may include (1) first graphical user interface controls for viewing the content item post reshared by Abe, (2) second graphical user interface controls for viewing Chrix's reaction to Bara's content item post, and (3) third graphical user interface controls for viewing or replying to Abe's private message.

In the example of FIG. 3C, unlike the examples of FIG. 3A and FIG. 3B, multiple alert-triggering actions are alerted to the recipient end-user 114 yet separate graphical user interface controls for taking further action with respect to individual ones of the alert-triggering actions are not provided. In the example of FIG. 3A, if the recipient end-user 114 interacts with graphical user interface controls 320, it is unambiguous which alert-triggering action the recipient end-user 114 is interested in (e.g., the message sent by Abe). Likewise, in the example of FIG. 3B if the recipient end-user 114 interacts with push notification 326. However, if the recipient end-user 114 interacts with the launch icon of the client application in the example of FIG. 3C, it is ambiguous which of the three alert-triggering actions the recipient end-user 114 is interested in. The recipient end-user 114 may be interested in some of them or all three of them.

It should be noted that while this ambiguity is typically present with alert badge notifications, the ambiguity can also be present with the e-mail messages and push notifications. In particular, a single e-mail message or a push notification can aggregate multiple alert-triggering actions and hence contain multiple alerts. For example, an e-mail message or a push notification might state “You have multiple unread messages” (multiple alerts for multiple alert-triggering actions) or “You have invitations to connect waiting from Abe and Chrix” (two alerts for two alert-triggering actions). In this example, if the recipient end-user 114 interacts with the e-mail message or the push notification it is ambiguous which of the messages or which of the invitations the recipient end-user 114 is interested in.

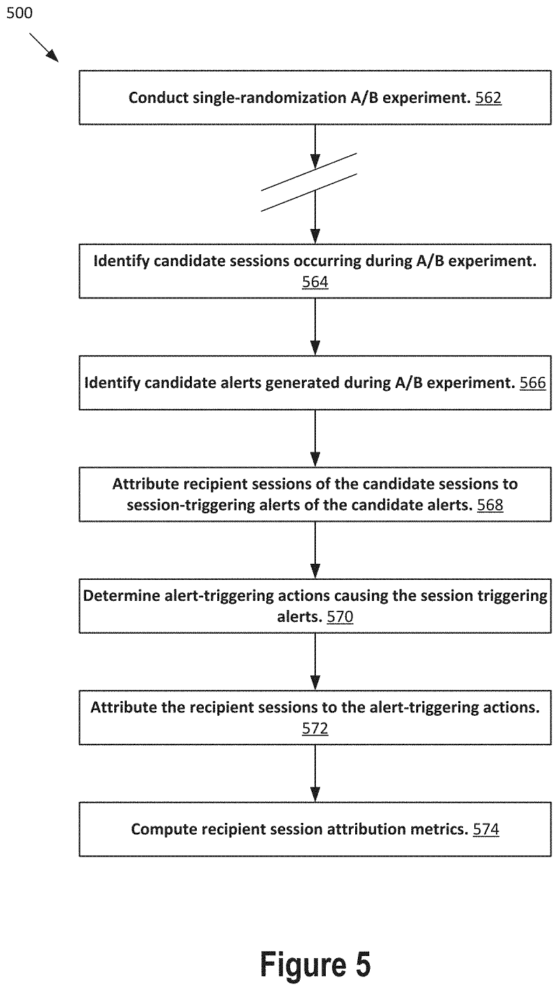

For purposes of recipient session attribution, in situations where it is unambiguous which alert-triggering action the recipient end-user 114 is interested in because the e-mail message, the push notification, or the badge notification alerts only about a single alert-triggering action (e.g., encompasses only a single alert), the entire session of the recipient end-user 114 may be attributed to the alert-triggering action. However, in situations where it is ambiguous which of multiple alert-triggering actions the recipient end-user 114 is interested in e-mail message, the push notification or the badge notification encompasses multiple alerts, then the fractional attribution of the session may be made. Whole and fractional attribution of recipient sessions to alert-triggering actions are discussed in greater detail below with respect to the example process of FIG. 5.

In some situations, a recipient end-user 114 may specifically acknowledge an alert where it is ambiguous which of multiple alerts the recipient end-user 114 is interested in. For example, in a summary graphical user interface presenting a summary of multiple alerts conveyed in an e-mail message, a push notification, or a badge notification, the recipient end-user 114 may interact with the graphical user interface controls for one of the summarized alert-triggering actions. In this case, the recipient end-user 114 has specifically acknowledged the alert-triggering action that the recipient end-user 114 is interested in. After specifically acknowledging a particular alert-triggering action, the recipient end-user 114 may return to the summary graphical user interface to specifically acknowledge another of the multiple alert-triggering actions summarized in the summary graphical user interface. In this way, the recipient end-user 114 may specifically acknowledge some, none, or all of the alert-triggering actions alerted with multiple alerts in a single e-mail, a single push notification, or a single badge notification. In some embodiments, when fractionally attributing a recipient session to multiple alert-triggering actions, a specifically acknowledged alert-triggering action may receive greater attribution (weight value) than an alert-triggering action that is not specifically acknowledged based on the specifically acknowledged alert-triggering action causing a greater level of engagement with online service 104 than the alert-triggering action that is not specifically acknowledged.

FIG. 3D illustrates examples of badge notification that alert a recipient end-user of alert-triggering actions taken using a client application and an online service by one or more initiating end-users, according to some embodiments of the present invention.

Badge alerts 336, 338, and 340 are presented in a toolbar 334 that is presented in a graphical user interface of the client application. The graphical user interface may be displayed on a video display of a client device 102 of a recipient end-user 114. In this example, there are three different types of badge alerts corresponding to three different types of alert-triggering actions. In particular, badge alerts 336 alert of invitations sent to the recipient end-user 114, badge alerts 338 alert of messages sent to the recipient end-user 114, and badge alerts 340 alert of reshare, reaction, comment, and post activity in the content item feed of the recipient end-user 114. In this example, there are three invitations, two messages, and twenty content item feed notifications.

Each of the badges associated with badge alerts 336, 338, and 340 may be interactive allowing the recipient end-user 114 to cause the client application to present a summary of the respective alert-triggering actions. For example, interacting (e.g., clicking on or otherwise selecting) with the “My Network” badge may cause the client application to present a summary graphical user interface for the three sent invitations. Likewise, interacting with the “Message” badge may cause the client application to present a summary graphical user interface for the two sent messages and interacting with the “Notifications” badge may cause the client application to present a summary graphical user interface for the twenty content item feed notifications. From a summary graphical user interface, the recipient end-user 114 can take a further action that specifically acknowledges one or more of the alert-triggering actions.

### 5. EXAMPLE ONLINE SERVICE COMPONENTS

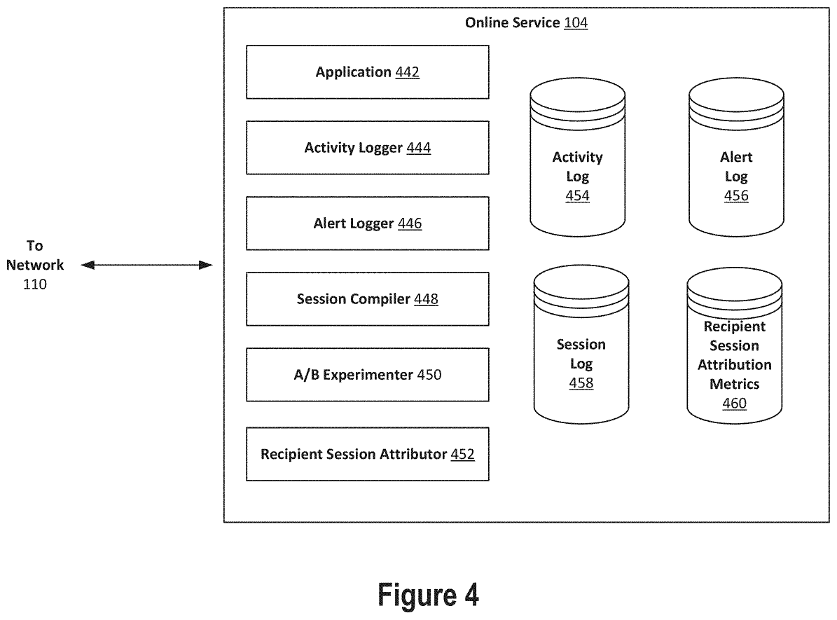

FIG. 4 illustrates example components of online service 104 in accordance with some embodiments of the present invention. The figure is for illustration purposes only and online service 104 can comprise fewer or more functional or storage components. Each of the functional components can be implemented as software components, general or specific-purpose hardware components, firmware components, or any combination thereof. A storage component can be implemented using any of relational databases, object databases, flat file systems, or JSON stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

Application 442, in conjunction with the client application, provides online service functionality to initiating end-users 112 and recipient end-users 114 at client devices 102. Such functionality may vary from online service 104 to online service 104 depending on the particular domain, market, or goal of the online service 104.

Application 442, in conjunction with client application, allows initiating end-users 112 to take alert-triggering actions and other actions such as viewing web pages using online service 104. Examples of alert-triggering actions are provided herein. However, application 442 is not limited to supporting any particular alert-triggering action or any particular set of alert-trigger actions and the set of alert-triggering actions may vary from online service 104 to online service 104.

Application 442, in cooperation with activity logger 444, may log alert-triggering actions taken in activity log 454. Application, in cooperation with activity logger 444, may also log pageviews in activity log 454 and actions by recipient end-users 114 specifically acknowledging alert-triggering actions. A log entry in activity log 454 may correspond to an end-user action taken using the client application and online service 104. A log entry in activity log 454 for an end-user action taken may indicate various information about the action taken such as: an identifier of the end-user that took the action (actor_id), the type of action taken (e.g., invite sent, message sent, pageview, reshare, comment, reaction, post, specific acknowledgement action, etc.), a timestamp (date and time) indicating when the action was taken by the end-user (action timestamp), and a uniform resource locator (URL) or other identifier that identifies the instance of the action taken, along with possibly other information about the action taken. Thus, activity log 454 is not limited logging information about alert-triggering actions but may also log information about other end-user actions such as pageviews, specific acknowledgment actions, etc. In some embodiments, all end-user actions taken by end-users using the client application and online service 104 that cause a network request (e.g., a HTTP or HTTPS request) to be sent from a client device 102 to application 442 via network 110 are logged in activity log 454.

Application 442 communicates alerts to recipient end-users 114 when alert-triggering actions are taken by initiating end-user 112. An alert may be communicated by application 442 to a recipient end-user 114 via an e-mail message sent to the recipient end-user 114, via a push notification sent to a client device 102 of the recipient end-user 114, or via a badge notification presented in a graphical user interface of the client application at a client device 102 of the recipient end-user 114. Application 442 may use the services of e-mail service 106 or push notification 108 to communicate alerts in e-mail messages and push notifications, respectively.

Application 442, in cooperation with alert logger 446, may log alerts communicated in alert log 456. A log entry or a set of log entries in alert log 456 may correspond to an alert communicated by application 442. The log entry may indicate various information about the alert communicated including: (1) an identifier of the recipient end-user 114 of the alert (recipient_id) and (2) a timestamp (date and time) when the alert is communicated (alert timestamp).

Session compiler 448 processes data in activity log 454 to identify sessions. A session is a period of time during which an end-user is deemed by session compiler 448 to continuously use online service 104. To identify sessions for an end-user in activity log 454, session compiler 448 can order log entries for the end-user in activity log 454 by time (e.g., by the action timestamp of the log entries). Each log entry represents an action taken by the end-user using the client application and the online service 104. A time gap greater than (or equal to) a threshold between consecutive actions by the end-user represents the start of a new session for the end-user. A time gap less than (or equal to) the threshold between consecutive actions by the end-user represents actions taken during the same session. An example of the threshold might be thirty minutes. However, the threshold time can vary according to the requirements of the particular implement at hand.

The above is just one example methodology session compiler 448 could employ to identifying sessions for end-users in activity log 454. However, other methodologies are possible, and no particular methodology is required. For example, session compiler 448 may identify a new session for an end-user if the end-user takes an action from a client device 102 that is different from the client device 102 from which the end-user took the prior action, even if the time gap between the two consecutive actions is below the time threshold.

When session compiler 448 identifies a new session in activity log 454 it stores a log entry in session log 458. The log entry may identify the end-user for which the session is identified (user_id) and identify the start time of the session (session timestamp). The log entry may identify or reference other information about the session such as the end-user actions (e.g., pageviews) of the session and timestamps for those actions indicating when the end-user actions were taken. The timestamp of the earliest end-user action of a session may be used as the start timestamp of the session.

A/B experimenter 450 may perform operations in conjunction with conducting A/B experiments in online service 104. Such operations may include randomizing end-users between treatment and control groups and ensuring only users in the treatment group are exposed to the treatment feature and that user in the control are not exposed to the treatment feature.

Recipient session attributor 452 processes data in activity log 454, alert log 456, and session log 458 to compute recipient session attribution metrics 460. Recipient session attribute metrics 460 can include per-action metrics and per-user metrics.

A recipient session attribute metric 460 for an alert-triggering action may encompass a count of the recipient sessions attributed to the alert-triggering action. If each recipient session attributed to the alert-triggering action is counted as one with an attribute weight value of 1.0 because there is no fractional attribution of the session(s) to the action, then the count of the set of recipient sessions attributed to the alert-triggering actions is the cardinality of the set. However, if a session is fractionally attributed to the alert-triggering action with a weight value between zero (0) and one (1), then the count of the recipient sessions attributed to the action may be a fractional value.

For example, if three sessions are wholly attributed to a given alert-triggering action, then recipient session attribution metric 460 for the action may be computed as 3.0. However, if a session of the three sessions is fractionally attributed to the action with an attribution weight value of 0.5 and the other two sessions are wholly attributed to the action, then the recipient session attribute metric 460 for the action may be computed as 2.5.

A per-user metric for an initiating end-user 112 may be computed as a sum of per-action metrics computed for a set of alert-triggering actions taken by the initiating end-user 112.

In the context of a single-randomization A/B experiment, per-action recipient session attribution metrics 460 computed for actions under test of the experiment taken by treatment users 221 in the treatment group 217 of the experiment can be compared to per-action recipient session attribution metrics 460 computed for the actions under test of the experiment taken by control users 223 in the control group 219 of the experiment. The comparison can be made to determine the extent of impact that the treatment feature had on recipient session activity. For example, an average per-action metric 460 for actions under test of the experiment taken by treatment users 221 that is higher than the average per-action metric 460 for the actions under test of the experiment taken by control users 223 may indicate that the treatment feature had a positive (desired) impact of recipient session activity in terms of increasing the level of end-user engagement with online service 104. On the other hand, an average per-action metric 460 for actions under test of the experiment taken by treatment users 221 that is lower than the average per-action metric 460 for the actions under test of the experiment taken by control users 223 may indicate that the treatment feature had a negative (undesired) impact of recipient session activity in terms of increasing the level of end-user engagement with online service 104.

In the context of a single-randomization A/B experiment, per-user recipient session attribution metrics 460 computed for treatment users 221 in the treatment group 217 of the experiment can be compared to per-user recipient session attribution metrics 460 computed for control users 223 in the control group 219 of the experiment. The comparison can be made to determine the extent of impact that the treatment feature had on recipient session activity. For example, an average per-user metric 460 for treatment users 221 of the experiment that is higher than the average per-user metric 460 for control users 223 of the experiment may indicate that the treatment feature had a positive (desired) impact of recipient session activity in terms of increasing the level of end-user engagement with online service 104. On the other hand, an average per-user metric 460 for treatment users 221 of the experiment that is lower than the average per-user metric 460 for control users 223 of the experiment may indicate that the treatment feature had a negative (undesired) impact of recipient session activity in terms of increasing the level of end-user engagement with online service 104.

### 6. EXAMPLE PROCESS

FIG. 5 illustrates an example process performed with online service 104 in accordance with some embodiments of the present invention. FIG. 5 is shown in simplified, schematic format for purposes of illustrating a clear example and other embodiments may include more, fewer, or different elements connected in various manners. FIG. 5 is intended to disclose an algorithm, plan or outline that can be used to implement one or more computer programs or other software elements which when executed cause performing the functional improvements and technical advances that are described herein.

FIG. 5 illustrates a process for recipient session attribution in context of a single randomization A/B experiment, according to some embodiments. In summary, the process proceeds by conducting 562 a single-randomization A/B experiment. After the experiment is conducted 562, a set of candidate sessions occurring while conducting 562 the experiment is identified 564. A set of candidate alerts generated while conducting 562 the experiment is also identified 566. Recipient sessions in the set of candidate sessions are attributed 568 to session-triggering alerts in the set of candidate alerts that triggered the recipient sessions. Then, the alert-triggering actions that caused the online service 104 to communicate the session-triggered alerts are determined 570. The recipient sessions are then attributed 572 to the alert-triggering actions that triggered the recipient sessions. Finally, recipient session attribution metrics are computed 574 based on the alert-triggering actions to which the recipient sessions are attributed 572.

As an example, a single-randomization A/B experiment may be conducted 562 with online service 104 over a period of time such as a number of days, weeks or months. The experiment may involve a type of alert-triggering action referred to herein as the “alert-triggering action under test.” For example, the experiment can be conducted 562 with online service 104 to determine whether a change to the graphical user interface workflow (the treatment feature) for sending invitations to connect in a social network cause initiating end-users 112 in the treatment group of the experiment to send more invitations to connect than initiating end-users 112 in the control group of the experiment that use the existing or alternative graphical user interface workflow (the control feature). Sending invitations to connect in a social network is just one example of a possible alert-triggering action that can be under test of the experiment. Other examples of a possible alert-triggering action that can be under test of the experiment include posting a content item in a social network, resharing a content item in a social network, sending a private message to one or more users in a social network, reacting to a content item post in a personalized content item feed, and commenting on a content item post in a personalized content feed. All of these actions taken by initiating end-users 112 may cause online service 104 to generate alerts notifying recipient end-users 114 that the actions were taken.

While the experiment is conducted 562, initiating end-users 112 may take the alert-triggering action under test and those instances logged in activity log 454 by activity logger 444. A log entry in activity log 454 for an end-user action taken may indicate various information about the action taken such as: an identifier of the end-user that took the action (actor_id), the type of action taken (e.g., invite sent, message sent, pageview, reshare, comment, reaction, post, specific acknowledgement action, etc.), a timestamp (date and time) indicating when the action was taken by the end-user (action timestamp), and a uniform resource locator (URL) or other identifier that identifies the instance of the action taken, along with possibly other information about the action taken.

Also, while the experiment is conducted 562, alerts communicated by online service 104 for the alert-triggering actions under test taken may be logged in alert log 456 by alert logger 446. A log entry in alert log 456 may indicate various information about an alert generated including: (1) an identifier of the recipient end-user 114 of the alert (recipient_id) and (2) a timestamp (date and time) when the alert is communicated (alert timestamp).

During or after the experiment is conducted 562, session compiler 448 may identify sessions from processing entries in activity log 454 and store a record of each such identified session in session log 458. The sessions identified and recorded in session log 458 may include sessions that occurred while the experiment is conducted 562. In some cases, a session may be considered to have occurred while the experiment is conducted 562 so long as the start time of the session is after the start time of the experiment and the start time of the session is before the end time of the experiment.

After the experiment has been conducted 562 and after session compiler 448 has identified the sessions that occurred while the experiment is conducted 562 and stored records of such sessions in session log 458, then operations 564 through 574 are performed.

At operation 564, a candidate set of sessions are identified 564 in session log 458. The candidate set of sessions identified 562 may include all sessions in session log 458 or a selected subset thereof. The candidate set of sessions may be identified 564 according to predetermined session identification criterion. The predetermined session identification criterion may be applied to log entries in session log 458 to select (identify 564) a subset of the log entries for inclusion in the candidate set of sessions. The predetermined session identification criterion may be based on a time period such as all sessions in session log 458 that have a start session timestamp that falls within a specified time period or all sessions in session log 458 that have a start session timestamp indicating that the session occurred while the experiment is conducted 562. The time period may be a particular day, days, week, or weeks, or other period of time. In addition to a time period, the predetermined session identification criterion may be based on other session attributes that are available such as, for example, user identifier or other attributes of the end-users that conducted the sessions. In this way, the set of candidate sessions may be limited to certain specifies types of sessions that occurred while the experiment is conducted 562 such as, for example, sessions by end-users in the United States that occurred while the experiment is conducted 562.

At operation 566, which may be performed before, concurrently, or after operation 564 is performed, a candidate set of alerts is identified 566 in alert log 456. The candidate set of alerts may include all alerts in alert log 456 or a selected subset thereof. For example, a subset could be selected such as, for example, all alerts in alert log 456 having an alert timestamp within a specified time period are selected such as, for example, an alert timestamp after the start time of the experiment conducted 562 and before the end time of the experiment conducted 562. Other criteria in addition to the time period of the alert communication may be used to select the candidate set of alerts. For example, an alert may be selected (identified 566) for inclusion in the candidate set of alerts based on the recipient end-user of the alert (the end-user to whom the alert is communicated) or based on the type of the alert (e.g., e-mail message, push notification, or badge notification). In this way, the candidate set of alerts identified 566 can be limited to certain types of alerts or only alerts that were communicated while the experiment is conducted 562 and that meet another specified criterion or that meet a set of other criteria.

At operation 568, sessions in the candidate set of sessions are attributed to the alerts in the candidate set of alerts that triggered those sessions. A session can be triggered by multiple alerts in the case where the alert notification (e.g., e-mail message, push notification, or badge notification) conveyed multiple alerts. In this case, the session may be fractionally attributed to the multiple alerts. For example, the session may be evenly attributed across the multiple alerts. For example, if there were two alerts in the alert notification, then one-half (0.5) of the session may be attributed 568 to each of the two alerts. However, fractional attribution schemes other than evenly are possible. For example, a session may be fractionally attributed to multiple alerts based on the alert timestamp where the most recent alert is attributed the greatest fraction of the session and the least recent alert is attributed the smallest fraction of the session.

A session in the candidate set of sessions may be attributed 568 to an alert in the candidate set of alerts based on log data in activity log 454, alert log 456, and session log 458. At a minimum, a session of a recipient end-user 114 is attributed 568 to an alert only if the alert is communicated to the recipient end-user 114 in an alert notification (e.g., e-mail message, push notification, or badge notification). For example, a log entry in session log 458 for a session may identify the same recipient end-user 114 as a log entry in the alert log 456 for an alert. In this case, the session can be (but is not necessarily) attributed to the alert. Assuming a given session and a given alert are for the same recipient end-user 114, two schemes for determining whether to attribute 566 the session to the alert are now described.

First Scheme—Direct Tracing

When a recipient end-user 114 receives one or more alerts in an alert notification such as an e-mail message, a push notification, or a badge notification, the recipient end-user 114 can interact with the alert notification as presented in a graphical user interface at a client device of the recipient end-user 114. Such interaction may include directing user input to the alert notification as presented in the graphical user interface such as, for example, clicking on the alert notification or directing a touch gesture to the alert notification as presented on a touch-sensitive display.

Interacting with the alert notification may cause the client application to launch at the client device and submit a URL or other hyperlink in a network request (e.g., a HTTP or HTTPS request) to online service 104 to retrieve information about the alert-triggering action or actions that triggered the alert or alerts that are the subject of the alert notification. This network request may continue an existing session for the recipient end-user 114 or start a new session for the recipient end-user 114.

The network request may specifically identify the alert or alerts that are the subject of the alert notification. For example, identifier(s) of the alert(s) may be embedded in the URL or hyperlink submitted in the network request. In this case, recipient session attributor 452 can attribute 568 the existing session or the new session to the alert or alerts specifically identified in the network request as the information for making the attribution is available in logs 454, 456, and 458.

Second Scheme—Time-Based Inference

If the network request caused by the recipient end-user 114 interacting with the alert notification does not specifically identify the alert(s) that are the subject of the alert notification, then a session for a recipient end-user 114 may be attributed 568 to an alert for the recipient end-user 114 based on time. In particular, the network request may identify the alert notification even if it does not specifically identify the alert(s) that are the subject of the alert notification. In this case, the network request can be attributed to a session of the recipient end-user 114 based on a time of the network request. That is, the time of the network request can be used to determine the one session to which the network request belongs. The alert(s) that are the subject of the alert notification that are recorded in alert log 456 can then be attributed 566 to the session.

For example, a network request from user “Abe” interacting with an alert notification can be associated with a session for “Abe” in session log 458 based on the time of the network request, the start time of the session, and the start time of Abe's next session. Abe's interaction with the alert notification causes the network request to be sent to the online service 104. The network request may identify the alert notification that Abe interacted with. For example, the alert notification may identify the alert notification in a header or attribute of the network request or in the URL of the network request. Online service 104 may maintain in alert log 456 an association between the alert notifications sent and the identifier of the one or more alerts that are the subject of the alert notifications sent. In this case, the identifier of the alert notification in the network request may be used to lookup in alert log 456 the alert(s) communicated in the alert notification. Then, having identified the session and the alert(s), the session may be attributed 568 to the alert(s).

As a result of operation 568, sessions in the candidate set of sessions are attributed to alerts in the candidate set of alerts that triggered the sessions. For each such session, the session may be attributed to one or more alerts. If a session is attributed to just one alert, then the session may be wholly attributed to the alert (e.g., with a weight value of 1.0). On the other hand, if a session is attributed to more than one alert, then then the session may be fractionally attributed to each alert (e.g., with a fractional weight value less than 1.0 and greater than 0.0). In some embodiments, if a session is attributed to more than one alert, then the session is attributed equally to each alert. For example, if a session is attributed to four alerts, then the session may be attributed weight a 0.25 to each of the four alerts.

At operation 570, for each alert to which a session is attributed 568, the alert-triggering action that caused online service 104 to communicate the alert is determined. This determination may be made from the alert log 456 as the log entry for the alert may identify the alert-triggering action and the initiating end-user 112 that took the alert-triggering action.

At operation 572, the sessions attributed 568 to the alerts are attributed to the alert-triggered actions determined 570 to have caused the alerts. This results in each recipient session being attributed to one or more alert-triggering actions. If a recipient session is attributed to just one alert-triggering action, then the session may be wholly attributed to the alert-triggering action (e.g., with a weight value of 1.0). On the other hand, if a session is attributed to more than one alert-triggering action, then then the session may be fractionally attributed to each alert-triggering action (e.g., with a fractional weight value less than 1.0 and greater than 0.0). The fractional weights may be taken from the corresponding alerts. For example, if a session is attributed to four alerts and the session is attributed equally to the four alerts with a weight value of 0.25 for each of the four alerts, then the session may be attributed likewise to the four alert-triggering actions that triggered the four alerts. For example, the session is attributed equally to the four alert-triggering actions with a weight value of 0.25 for each of the four alert-triggering actions.

In some situations, a recipient end-user 114 may specifically acknowledge an alert where it is ambiguous which of multiple alerts the recipient end-user 114 is interested in. For example, in a summary graphical user interface presenting a summary of multiple alerts conveyed in an e-mail message, a push notification, or a badge notification, the recipient end-user 114 may interact with the graphical user interface controls for one of the summarized alert-triggering actions. In this case, the recipient end-user 114 has specifically acknowledged the alert-triggering action that the recipient end-user 114 is interested in. After specifically acknowledging a particular alert-triggering action, the recipient end-user 114 may return to the summary graphical user interface to specifically acknowledge another of the multiple alert-triggering actions summarized in the summary graphical user interface. In this way, the recipient end-user 114 may specifically acknowledge some, none, or all of the alert-triggering actions alerted with multiple alerts in a single e-mail, a single push notification, or a single badge notification. In some embodiments, when fractionally attributing a recipient session to multiple alert-triggering actions, a specifically acknowledged alert-triggering action may receive greater attribution(weight) than an alert-triggering action that is not specifically acknowledged based on the specifically acknowledged alert-triggering action causing a greater level of engagement with online service 104 than the alert-triggering action that is not specifically acknowledged.

The weight values may set or adjusted if the recipient end-user 114 of the session specifically acknowledged one or more of the multiple alert-triggering actions. For example, for a session attributed 570 to multiple alert-triggering actions, the weights of alert-triggering actions that are specifically acknowledged by the recipient end-user 114 as indicated by activity log 454 may be boosted over the weights of alert-triggering actions that were not specifically acknowledged. For example, if a session is initially attributed to four alert-triggering actions equally with an initial weight value of 0.25 for each of the four alert-triggering actions and the recipient end-user specifically acknowledged a particular one of the four alert-triggering actions, then the weight value for the particular alert-triggering action may be boosted relative to the other three weight values. For example, the session may be attributed by half to the particular alert-triggering action with a weight value of 0.50 and the other half of the session is attributed equally to the remaining three alert-triggering actions each with a weight value of 0.50/3. Other boosting schemes are possible, and no particular boosting scheme is required. Any boosting scheme that boosts the weight values for specifically acknowledged alert-triggering actions over alert-triggering actions that were not specifically acknowledged where the sum of all weights for all alert-triggering actions attributes to the session equals 1.0 may be used.

With the attributions 572 made, recipient attribution session metrics 460 can be computed 574. In particular, for a given alert-triggering action, an “action” score 460 can be computed 574 for the action based on a sum of the weights of the recipient sessions attributed to the given alert-triggering action. Recall that multiple recipient sessions can be attributed 572 to the given alert-triggering action. For example, a content item post, a comment or a reaction to a content item post, or a message addressed to multiple recipients can trigger multiple recipient sessions.

In addition, for a given initiating end-user, a “user” score 460 can be computed based on a sum of the action scores 460 computed for a set of alert-triggering actions taken by the given initiating end-user. For example, the set of alert-triggering actions taken by the given initiating end-user may be all instances of the alert-triggering action under test taken by the given initiating end-user while the experiment is conducted 562.

In the context of the A/B experiment conducted 562, an action score can be computed 574 for each instance of the alert-triggering action taken under test while the experiment is conducted 562. Then, the action scores computed 562 for the instances of the alert-triggering action under test taken by treatment users 221 can be compared to the action scores computed 562 for the instances of the alert-triggering action under test taken by control users 223 to determine the recipient or secondary impact of the treatment feature. A sum of the actions scores computed 574 for the treatment users 221 that is greater than a sum of the action scores computed 574 for the control users 223 may indicate that the treatment feature of the experiment conducted 562 causes more recipient sessions than the existing or alternative feature of the experiment conducted 562. On the other hand, if the sum of the action scores computed 574 for the treatment users 221 is less than the sum of the action scores computed 574 for the control users 223, then the treatment feature may have a negative recipient session impact.

In addition, in the context of the A/B experiment conducted 562, a user score can be computed 574 for each treatment user 221 that took the alert-triggering action under test while the experiment is conducted 562. And a user score can be computed 574 for each control user 223 that took the alert-triggering action under test while the experiment is conducted 562. Then, the user scores computed 562 for the treatment users 221 that took the alert-triggering action under test can be compared to the user scores computed 562 for the control users 223 that took the alert-triggering action under test to determine the recipient or secondary impact. A sum of the user scores computed 574 for the treatment users 221 that is greater than a sum of the user scores computed 574 for the control users 223 may indicate that the treatment feature of the experiment conducted 562 causes more recipient sessions (has greater recipient session impact) than the existing or alternative feature of the experiment conducted 562. On the other hand, if the sum of the use scores computed 574 for the treatment users 221 is less than the sum of the user scores computed 574 for the control users 223, then the treatment feature may have a negative recipient session impact.

While recipient session attribution metrics 460 including per-action scores and per-user scores can be used to evaluate the recipient session impact of the treatment feature of a single-randomization A/B experiment, they can be used for other purposes such as, for example, as machine learning features of training examples when a training machine learning model or as machine learning features of a sample when using the trained model to make an inference about the sample.

### 6. HARDWARE IMPLEMENTATION

According to some embodiments of the present invention, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

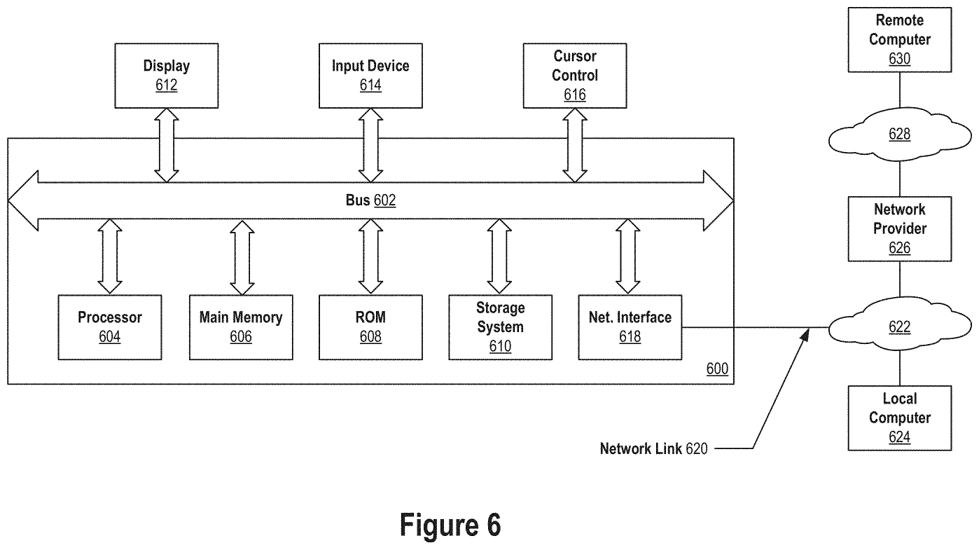

FIG. 6 is a block diagram that illustrates an example computer system with which some embodiments may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disk such as CD-ROM or DVD-ROM, and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 600 may be coupled via I/O subsystem 602 to at least one output device 612. In some embodiments, output device 612 is a digital computer display. Examples of a display that may be used in some embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on display 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In some embodiments, computer system 600 may comprise an internet of things (IoT) device in which one or more of the output device 612, input device 614, and control device 616 are omitted. In some embodiments, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to some embodiments, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In some embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to bus 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or NoSQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In some embodiments, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In some embodiments, for security and reliability, an operating system may prevent direct communication between independent processes, providing strictly mediated and controlled inter-process communication functionality.

### 7. OTHER ASPECTS OF THE DISCLOSURE

Unless the context clearly indicates otherwise, the term “or” is used in the foregoing specification and in the appended claims in its inclusive sense (and not in its exclusive sense) so that when used, for example, to connect a list of elements, the term “or” means one, some, or all of the elements in the list.

Unless the context clearly indicates otherwise, the terms “comprising,” “including,” “having,” “based on,” “encompassing,” and the like, are used in the foregoing specification and in the appended claims in an open-ended fashion, and do not exclude additional elements, features, acts, or operations.

Unless the context clearly indicates otherwise, conjunctive language such as the phrase “at least one of X, Y and Z,” is to be understood to convey that an item, term, etc. may be either X, Y or Z, or a combination thereof. Thus, such conjunctive language is not intended to imply that certain embodiments require at least one of X, at least one of Y and at least one of Z to each be present.

Unless the context clearly indicates otherwise, as used in the foregoing detailed description and in the appended claims, the singular forms “a,” “an,” and “the” are intended to include the plural forms as well.

Unless the context clearly indicates otherwise, in the foregoing detailed description and in the appended claims, although the terms first, second, etc. are, in some instances, used herein to describe various elements, these elements should not be limited by these terms. These terms are only used to distinguish one element from another. For example, a first computing device could be termed a second computing device, and, similarly, a second computing device could be termed a first computing device. The first computing device and the second computing device are both computing devices, but they are not the same computing device.

In the foregoing specification, some embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
at one or more computer systems comprising one or more processors and storage media storing one or more computer programs comprising computer-executable instructions executed by the one or more computer systems to perform the following operations:
storing record of a plurality of end-user sessions that occurred while a single-randomization AB experiment was conducted with an online service;
for each end-user session, identifying one or more end-user activity alerts that triggered the end-user session, and
for each end-user session, attributing the end-user session to one or more alert-triggering actions that caused the one or more end-user activity alerts that triggered the end-user session to be communicated by the online service; and
computing a recipient session attribution metric for a particular alert-triggering action based on the one or more end-user sessions, of the plurality of end-user sessions, attributed to the particular alert-triggering action.

2. The method of claim 1, wherein the computer-executable instructions are executed by the one or more computer systems to further perform the following operation:
outputting the recipient session attribution metric to a computer-generated report, a computer database, or a computer user interface.

3. The method of claim 1, wherein the computer-executable instructions are executed by the one or more computer systems to further perform the following operation:
computing the recipient session attribution metric as the cardinality of the one or more end-user sessions attributed to the particular alert-triggering action.

4. The method of claim 1, wherein the computer-executable instructions are executed by the one or more computer systems to further perform the following operations:
determining that a particular end-user session was triggered by two or more end-user activity alerts, wherein the particular end-user session is one of the one or more end-user sessions attributed to the particular alert-triggering action;
assigning each end-user activity alert of the two or more end-user activity alerts a respective weight value; and
computing the recipient session attribution metric for the particular alert-triggering action based on the respective weight values assigned to the two or more end-user activity alerts.

5. The method of claim 4, wherein the assigning each end-user activity alert of the two or more end-user activity alerts a respective weight value is based on assigning each end-user activity alert of the two or more end-user activity alerts the same weight value.

6. The method of claim 4, wherein the assigning each end-user activity alert of the two or more end-user activity alerts a respective weight value is based on assigning at least two end-user activity alerts of the two or more end-user activity alerts different weight values.

7. The method of claim 4, wherein the computer-executable instructions are executed by the one or more computer systems to further perform the operations of:
determining that a recipient end-user that conducted the particular end-user session specifically acknowledged a first end-user activity alert of the two or more end-user activity alerts;
determining that the recipient end-user did not specifically acknowledge a second end-user activity alert of the two or more end-user activity alerts; and
wherein the assigning each end-user activity alert of the two or more end-user activity alerts a respective weight value is based on assigning the first end-user activity alert a greater respective weight value that the respective weight value assigned to the second end-user activity alert.

8. The method of claim 1, wherein the computer-executable instructions are executed by the one or more computer systems to further perform the operation of:
while the single-randomization A/B experiment is conducted with the online service, communicating a plurality of end-user activity alerts to a plurality of recipient end-users in a plurality of alert notifications, each end-user activity alert of the plurality of end-user activity alerts communicated for an alert-triggering action taken by an end-user of the online service.

9. The method of claim 8, wherein each alert notification of the plurality of alert notifications is one of an e-mail message, a push notification, or a badge notification.

10. The method of claim 1, wherein the computer-executable instructions are executed by the one or more computer systems to further perform the operation of:
selecting, from among a plurality of alert-triggering actions, the particular alert-triggering action for which to compute the recipient session attribution metric based on determining that an end-user user that took the particular alert-triggering action was assigned to a treatment group of the single-randomization A/B experiment.

11. A computing system comprising:
one or more processors;
storage media; and
computer-executable instructions stored in the storage media and which, when executed by the computing system, cause the computing system to perform the following operations:
storing record of a plurality of end-user sessions that occurred while a single-randomization A/B experiment was conducted with an online service;
for each end-user session, identifying one or more end-user activity alerts that triggered the end-user session, and
for each end-user session, attributing the end-user session to one or more alert-triggering actions that caused the one or more end-user activity alerts that triggered the end-user session to be communicated by the online service; and
for each alert-triggering action of a plurality of alert-triggering actions taken by end-users of the online service while a single-randomization A/B experiment was conducted with the online service, computing a recipient session attribution metric for the alert-triggering action based on the one or more end-user sessions, of the plurality of end-user sessions, attributed to the alert-triggering action.

12. The computing system of claim 11, further comprising computer-executable instructions stored in the storage media and which, when executed by the computing system, cause the computing system to perform the following operation:
for each alert-triggering action of the plurality of alert-triggering actions, outputting the recipient session attribution metric computed for the alert-triggering action to a computer-generated report, a computer database, or a computer user interface.

13. The computing system of claim 11, further comprising computer-executable instructions stored in the storage media and which, when executed by the computing system, cause the computing system to perform the following operation:
for each alert-triggering action of the plurality of alert-triggering actions, computing the recipient attribution metric for the alert-triggering action as the cardinality of the one or more end-user sessions attributed to the alert-triggering action.

14. The computing system of claim 11, further comprising computer-executable instructions stored in the storage media and which, when executed by the computing system, cause the computing system to perform the following operations:
determining that a particular end-user session was triggered by two or more end-user activity alerts, wherein the particular end-user session is one of the one or more end-user sessions attributed to a particular alert-triggering action of the plurality of alert-triggering actions;
assigning each end-user activity alert of the two or more end-user activity alerts a respective weight value; and
computing the recipient attribution metric for the particular alert-triggering action based on the respective weight values assigned to the two or more end-user activity alerts.

15. The computing system of claim 11, further comprising computer-executable instructions stored in the storage media and which, when executed by the computing system, cause the computing system to perform the following operation:
while the single-randomization A/B experiment is conducted with the online service, communicating a plurality of end-user activity alerts to a plurality of recipient end-users in a plurality of alert notifications, each end-user activity alert of the plurality of end-user activity alerts communicated for one alert-triggering action of the plurality of alert-triggering actions.

16. The computing system of claim 11, further comprising computer-executable instructions stored in the storage media and which, when executed by the computing system, cause the computing system to perform the following operations:
selecting the plurality of alert-triggering actions for which to compute the recipient session attribution metrics based on determining that the plurality of alert-triggering actions were taken by end-users assigned to a treatment group of the single-randomization A/B experiment.

17. The computing system of claim 11, wherein the plurality of alert-triggering actions are all a same type of alert-triggering action under test of the single-randomization A/B experiment.

18. The computer system of claim 17, wherein the same type of alert-triggering action is one of the following types of alert-triggering actions:
sending an invitation to connect in an online social network,
commenting on a content item post in a personalized content item feed provided by an online social network,
resharing a content item post from a personalized content item feed provided by an online social network,
sending a private message to one or more end-users in an online social network,
reacting to a content item post in a personalized content item feed provided by an online social network, or
posting a content item to an online social network.

19. One or more non-transitory storage media storing computer-executable instructions which, when executed by a computing system comprising one or more processors, cause the computing system to perform the following operations:
storing record of a plurality of end-user sessions that occurred while a single-randomization A/B experiment was conducted with an online service;
for each end-user session, identifying one or more end-user activity alerts that triggered the end-user session;
for each end-user session, attributing the end-user session to one or more alert-triggering actions that caused the one or more end-user activity alerts that triggered the end-user session to be communicated by the online service;
wherein the single-randomization A/B experiment has a treatment group to which end-users are assigned and a control group to which end-users are assigned;
for each alert-triggering action of a first plurality of alert-triggering actions taken by end-users assigned to the treatment group, computing a recipient session attribution metric for the alert-triggering action based on the one or more end-user sessions, of the plurality of end-user sessions, attributed to the alert-triggering action; and
for each alert-triggering action of a second plurality of alert-triggering actions taken by end-users assigned to the control group, computing a recipient session attribution metric for the alert-triggering action based on the one or more end-user sessions, of the plurality of end-user sessions, attributed to the alert-triggering action.

20. The one or more non-transitory storage media of claim 19, further comprising computer-executable instructions which, when executed by the computing system, cause the computing system to perform the following operations:
computing a first sum of the recipient session attribution metrics computed for the first plurality of alert-triggering actions;
computing a second sum of the recipient session attribution metrics computed for the second plurality of alert-triggering actions; and
outputting the first sum and the second sum to a computer-generated report, a computer database, or a computer user interface.
